(19) United States
(12) Patent Application Publication
(10) Pub. No.: US 2015/0067155 A1
(43) Pub. Date: Mar. 5, 2015

(54) SYSTEMS AND METHODS FOR MEASURING APPROXIMATE ENGAGEMENT OF USERS IN A SOFTWARE APPLICATION

(71) Applicant: Tune, Inc., Seattle, WA (US)

(72) Inventor: Niek Sanders, Seattle, WA (US)

(21) Appl. No.: 14/473,948

(22) Filed: Aug. 29, 2014

Related U.S. Application Data
(60) Provisional application No. 61/871,742, filed on Aug. 29, 2013.

(51) Int. Cl. H04L 29/08; H04L 12/26

(52) U.S. Cl. CPC H04L 67/22; H04L 43/10
USPC 709/224

(57) ABSTRACT

Methods and systems are provided for measuring user engagement with an application. Heartbeat messages are sent from the application being monitored on a mobile computing device to a tracking server. Heartbeat messages may be stored on the mobile computing device for later transmission to the tracking server in situations where network connectivity is unavailable. A user session record is stored by the tracking server, and is closed upon a failure to receive a heartbeat message before a timeout interval elapses. A closed user session record may be reopened upon receiving a subsequent heartbeat message associated with the formerly closed user session.

### CROSS-REFERENCE TO RELATED APPLICATION

This application claims the benefit of Provisional Application No. 61/871742, filed Aug. 29, 2013, the entire disclosure of which is hereby incorporated by reference herein for all purposes.

### BACKGROUND

Application developers and advertisers would generally like to know how much a user engages with a particular software application after the application has been downloaded and/or installed on a computing device associated with the user. Such information can help provide appropriate compensation to advertising publishers, and also can help application developers to improve their applications. What is needed are methods and systems that allow for the measurement of user engagement in software applications.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a computer-implemented method of determining end user engagement with an application installed on an end user computing device is provided. A tracking server receives a first heartbeat message from the end user computing device, wherein the heartbeat message includes a tracking identifier and a session identifier. The tracking server creates a user session record including the tracking identifier, the session identifier, and an open status. The tracking server detects that a timeout period has elapsed without receiving a subsequent heartbeat message that includes the tracking identifier and the session identifier, and the tracking server updates the user session record from the open status to a closed status.

In some embodiments, a nontransitory computer-readable medium having computer-executable instructions stored thereon is provided. The instructions, in response to execution by one or more processors of an end user computing device, cause the end user computing device to perform actions for measuring user engagement with an application installed on the end user computing device. The actions performed by the end user computing device comprise generating a session identifier in response to detecting a launch of the application; creating a heartbeat message that includes the session identifier and a tracking identifier associated with the end user computing device; and creating a subsequent heartbeat message that includes the session identifier and the tracking identifier after waiting a predetermined amount of time.

In some embodiments, a tracking system is provided. The tracking system comprises a storage service server and a tracking server. The storage service server is configured to provide a tracking data store. The tracking server is configured to provide a tracking engine configured to receive a first heartbeat message from an end user computing device, wherein the heartbeat message includes a tracking identifier and a session identifier; storing a user session record in the tracking data store, the user session record including the tracking identifier, the session identifier, and an open status; detecting that a timeout period has elapsed without receiving a subsequent heartbeat message that includes the tracking identifier and the session identifier; and updating the user session record from the open status to a closed status.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic diagram that illustrates an exemplary embodiment of a tracking ecosystem according to various aspects of the present disclosure;

FIG. 2 is a block diagram that illustrates details of an exemplary embodiment of an end user computing device and a tracking system according to various aspects of the present disclosure;

FIG. 3 is a flowchart that illustrates an exemplary embodiment of a method of configuring a device to report application usage for measuring user engagement according to various aspects of the present disclosure;

FIG. 4 is a flowchart that illustrates an exemplary embodiment of a method of transmitting information to report application usage for measuring user engagement according to various aspects of the present disclosure;

FIG. 5 is a flowchart that illustrates a method of receiving information to analyze application usage for measuring user engagement according to various aspects of the present disclosure; and

FIG. 6 is a diagram of hardware and an operating environment in conjunction with which implantations of the one or more computing devices of the system 100 may be practiced.

### DETAILED DESCRIPTION

### Tracking System Overview

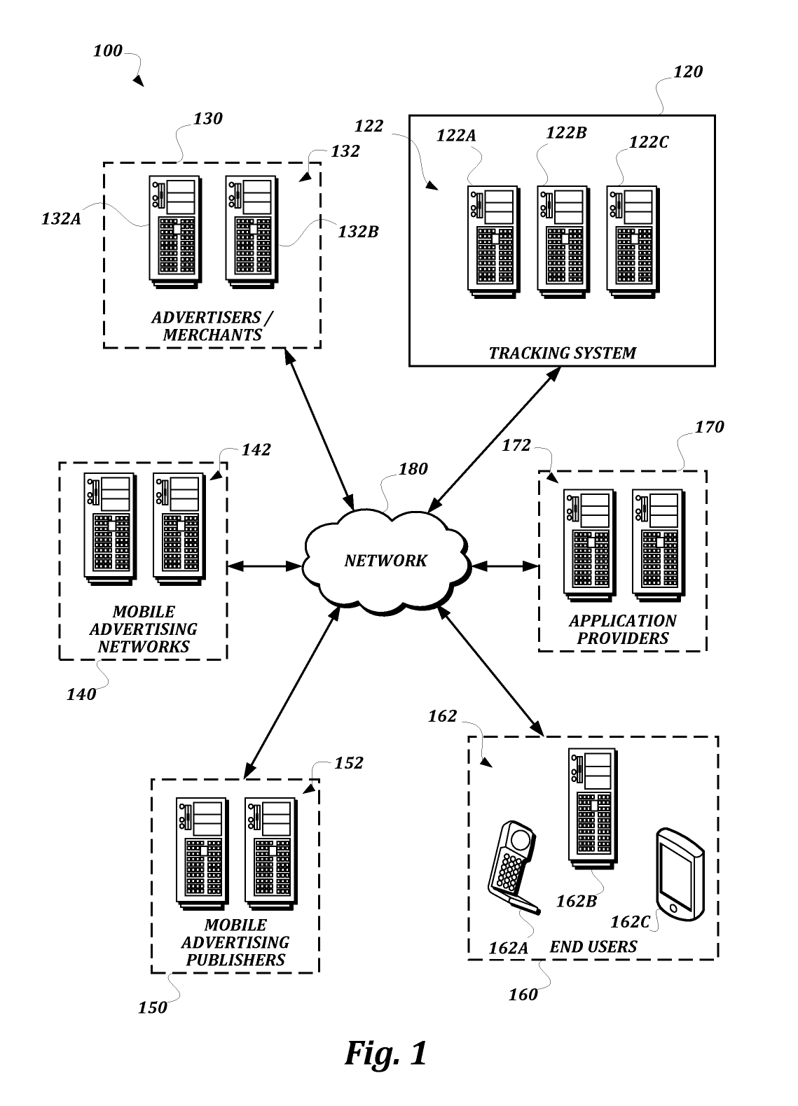

FIG. 1 is a schematic diagram that illustrates an exemplary embodiment of a tracking ecosystem 100 according to various aspects of the present disclosure. The tracking ecosystem 100 may be configured to match interactions with (e.g., clicks on) advertisements with subsequent installations and usage of applications associated with the selected advertisements. This matching may allow such actions may be attributed to the appropriate party or parties that provided (e.g., distributed and/or displayed) the selected advertisements to those who interacted with the advertisements and installed the applications. The tracking ecosystem 100 may also be configured to analyze usage of the applications in order to measure user engagement. Such measurements of user engagement may then allow a value to be placed on the user, and a reward provided for the attribution of the actions to be altered accordingly.

As illustrated, the system 100 includes a tracking system 120. The tracking system 120 includes one or more computing devices 122. In the embodiment illustrated, the computing devices 122 include a tracking server 122A, a storage service server 122B, and a management interface server 122C. In alternate embodiments, the computing devices 122 may include multiple tracking servers, multiple storage service servers, and/or multiple management interface servers. In some embodiments, the storage service server 122B is external to (and optionally remote from) the tracking system 120. In other embodiments, the functionality of the tracking server 122A and the storage service server 122B may be combined on a single computing device (not shown). In some embodiments, the functionality of the tracking server 122A and the management interface server 122C may be combined on a single computing device (not shown). The tracking system 120 is not limited to the use of a particular number of computing devices to implement the functionality of the tracking server 122A, the storage service server 122B, and the management interface server 122C.

The system 100 also includes one or more computing devices 132 operated by one or more Advertisers/Merchants 130, one or more computing devices 142 operated by one or more Mobile Advertising Networks 140, one or more computing devices 152 operated by one or more Mobile Advertising Publishers 150, a plurality of computing devices 162 operated by a plurality of End Users 160, and one or more computing devices 172 operated by one or more Application Providers 170.

As is apparent to those of ordinary skill in the art, in some embodiments, a single entity may function as one of the Advertisers/Merchants 130, one of the Mobile Advertising Networks 140, and one of the Mobile Advertising Publishers 150, even though they are illustrated in FIG. 1 as separate entities. Such an entity may operate one or more computing devices (not shown) that perform the functions of the computing devices 132, 142, and 152.

The Advertisers/Merchants 130 include companies that wish to advertise products (e.g., software applications) and/or services. As is apparent to those of ordinary skill in the art, to receive some services, the computing devices 162 may be required to install one or more software applications.

The Mobile Advertising Networks 140 include companies that help distribute advertisements for the Advertisers/Merchants 130 for presentation to end users. The Mobile Advertising Networks 140 may provide services to Mobile Advertising Publishers 150 that allow Mobile Advertising Publishers 150 to present advertisements received from the Mobile Advertising Networks 140 to end users. Non-limiting examples of such companies include Google (the AdWords platform), Apple (the iAd platform), Millennial Media, Tapjoy, InMobi, Advertising.com, AdColony, Jumptap, Nexage, and the like.

The Mobile Advertising Publishers 150 include providers of web sites and mobile applications that display advertisements. Non-limiting examples of such companies include Pandora, Spotify, Facebook, Twitter, Bittorrent.com, The Weather Channel, and any other application or website provider that displays advertisements. In some embodiments, a company may act as both a Mobile Advertising Network 140 and a Mobile Advertising Publisher 150.

The End Users 160 include people who use the computing devices 162 and interact with advertisements, such as those created by the Advertisers/Merchants 130, distributed by the Mobile Advertising Networks 140, and/or displayed by the Mobile Advertising Publishers 150. The End Users 160 also use the computing devices 162 to purchase, download, install, and/or interact with applications provided by the Application Providers 170.

The Application Providers 170 include companies that provide installable applications (such as those advertised by the Advertisers/Merchants 130) to the End Users 160. Non-limiting examples of such companies include “app stores,” such as iTunes App Store, Google Play, Amazon Appstore, and the like. The one or more computing devices 172 may be configured to generate a download page (not shown) from which an application may be purchased, downloaded, and/or installed. The download page may be implemented as a webpage.

The computing devices 122, 132, 142, 152, 162, and 172 are connected to one another by a network 180 (e.g., the Internet). Each of the computing devices 122, 132, 142, 152, 162, and 172 may be implemented using a computing device similar to the computing device 12 illustrated in FIGURE QZ and described below. By way of non-limiting examples, the computing devices 162 have been illustrated as including a cellular telephone 162A, a personal computer 162B (e.g., a desktop computer), and a tablet computer 162C. Each of the computing devices 162 may be configured to implement an advertisement displaying application, such as an Internet browser application, and/or a different application configured to display advertisements.

### End User Computing Device Configured for Measuring Engagement

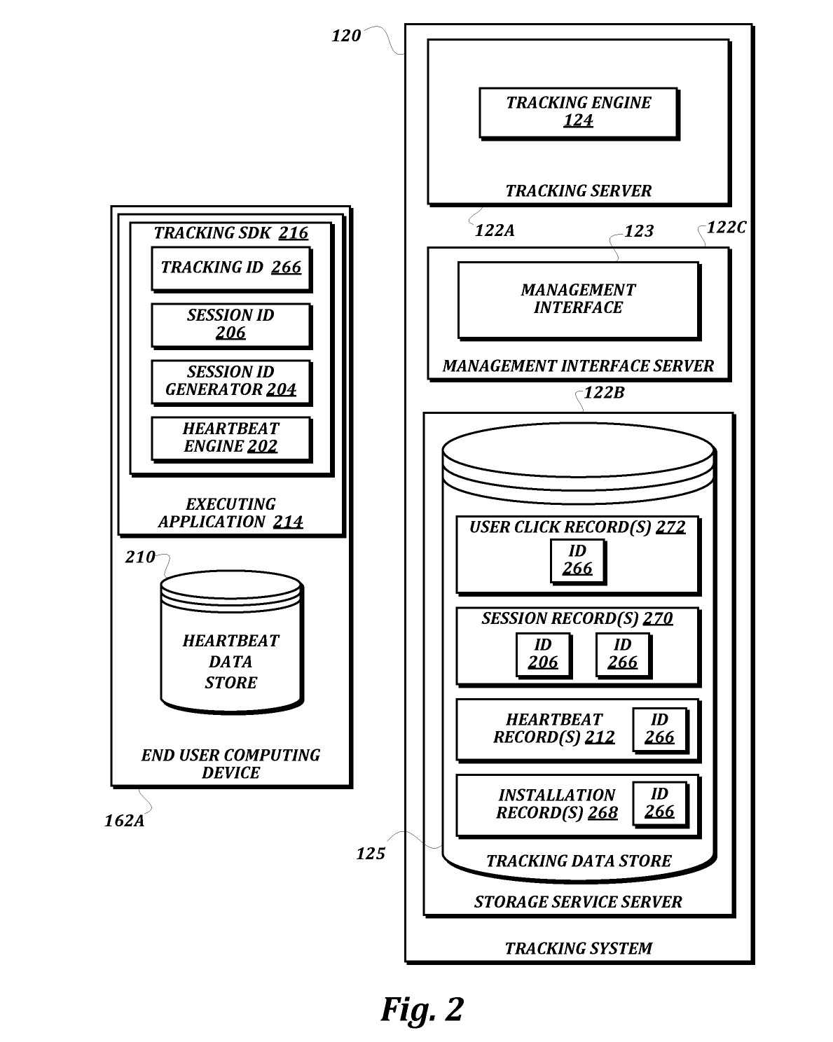

FIG. 2 is a block diagram that illustrates details of an exemplary embodiment of an end user computing device 162A and a tracking system 120 according to various aspects of the present disclosure.

The tracking server 122A is configured to provide a tracking engine 124 that communicates with the storage service server 122B. In general, the term “engine” as used herein refers to logic embodied in hardware or software instructions, which can be written in a programming language, such as C, C++, Objective-C, COBOL, JAVA™, PHP, Perl, HTML, CSS, JavaScript, Ruby, VBScript, ASPX, Microsoft .NET™ languages such as C#, and/or the like. An engine may be compiled into executable programs or written in interpreted programming languages. Software engines may be callable from other engines or from themselves. Generally, the engines described herein refer to logical modules that can be merged with other engines or applications, or can be divided into sub-engines. The engines can be stored in any type of computer-readable medium or computer storage device and be stored on and executed by one or more general purpose computers, thus creating a special purpose computer configured to provide the engine.

The storage service server 122B is configured to provide a tracking data store 125 that stores tracking, installation, heartbeat, and/or user session information received from the tracking server 122A and/or the management interface server 122C. As understood by one of ordinary skill in the art, a “data store” as described herein may be any suitable device configured to store data for access by a computing device. One example of a data store is a highly reliable, high-speed relational database management system (DBMS) executing on one or more computing devices and accessible over a high-speed network. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, as described further below. One of ordinary skill in the art will recognize that separate data stores described herein may be combined into a single data store, and/or a single data store described herein may be separated into multiple data stores, without departing from the scope of the present disclosure.

In some embodiments, the tracking data store 125 is configured to store a set of user click records 272, a set of session records 270, a set of heartbeat records 212, and a set of installation records 268. In some embodiments, each record of the heartbeat records 212, the session records 270, the installation records 268, and the user click records 272 stored by the tracking data store 125 is associated with a tracking identifier 266. The tracking identifier 266 may be used to associate the stored records with a particular user and/or a particular end user computing device 162.

In some embodiments, the tracking identifier 266 may be generated and assigned to the user or the end user computing device 162 by the tracking system 120. In some embodiments, the tracking identifier 266 may include device information that comprises at least one device identifier and/or other information associated with one of the computing devices 162 (see FIG. 1) that was not assigned by the tracking system 122. The device identifiers may be assigned to the computing devices 162 to uniquely identify the computing devices 162, and may therefore be used by the tracking system 122 to uniquely identify the end user computing device 162 or the user thereof.

Examples of device identifiers include, but are not limited to, a media access control (“MAC”) Address, an International Mobile Station Equipment Identity (“IMEI”), a Mobile Equipment Identifier (“MEID”), an Identifier for Advertising (“IFA”), an Identifier for Vendor (“IFV”), an Android ID, an Open Device Identification Number (“ODIN”), an Open Unique Device Identifier (“Open UDID”), combinations thereof, and the like. By way of a non-limiting example, the IMEI may be an Android IMEI. By way of another non-limiting example, the MEID may be an Android MEID.

The other information associated with one of the computing devices 162 (see FIG. 1) may include an Internet Protocol (“IP”) Address, browser information (e.g., browser type, browser version, etc.), combinations thereof, and the like. The other information may be usable to identify a computing device 162, though the other information may be less reliable for uniquely identifying a computing device 162 than the device identifiers. Optionally, all or a portion of the device information may be hashed instead of being stored directly in plain text in the tracking identifier 266.

In some embodiments, the tracking engine 124 may use the tracking data store 125 to store the heartbeat records 212. In some embodiments, the tracking system 120 may receive information relating to heartbeat events, but may use the information contained therein to update session records 270 instead of storing the heartbeat events 212 themselves in the tracking data store 125.

In some embodiments, the user click records 272 may indicate user interactions with advertisements provided by mobile advertising publishers 150, and may be associated with other records to attribute actions taken by a user to the advertising publishers 150 that encouraged the action. Further details regarding how user click records may be used to attribute actions to advertising publishers 150 and provide credit for doing so may be found in commonly owned, co-pending U.S. patent application Ser. No. 13/902691, filed May 24, 2013, the entire disclosure of which is hereby incorporated by reference for all purposes.

In some embodiments, the session records 270 are configured to store information about usage for an application tracked by the tracking system 120. For example, a session record 270 may include information such as a date and/or time a user session started and/or ended, an indication of whether the user session is currently active or closed, a session identifier 206 associated with the user session, a tracking identifier 266 associated with the user session, an identifier of the application itself, and/or the like. The session records 270 allow the tracking system 120 to produce reports and provide credit based on user engagement with the application, as discussed further herein.

The management interface server 122C includes a management interface engine 123 configured to generate a management interface, described below. The management interface engine 123 is configured to access (e.g., via an Application Programming Interface (“API”) or other suitable technique) the information stored in the tracking data store 125 and use the information to generate displays (e.g., graphs, charts, lists, reports, etc.) for the management interface.

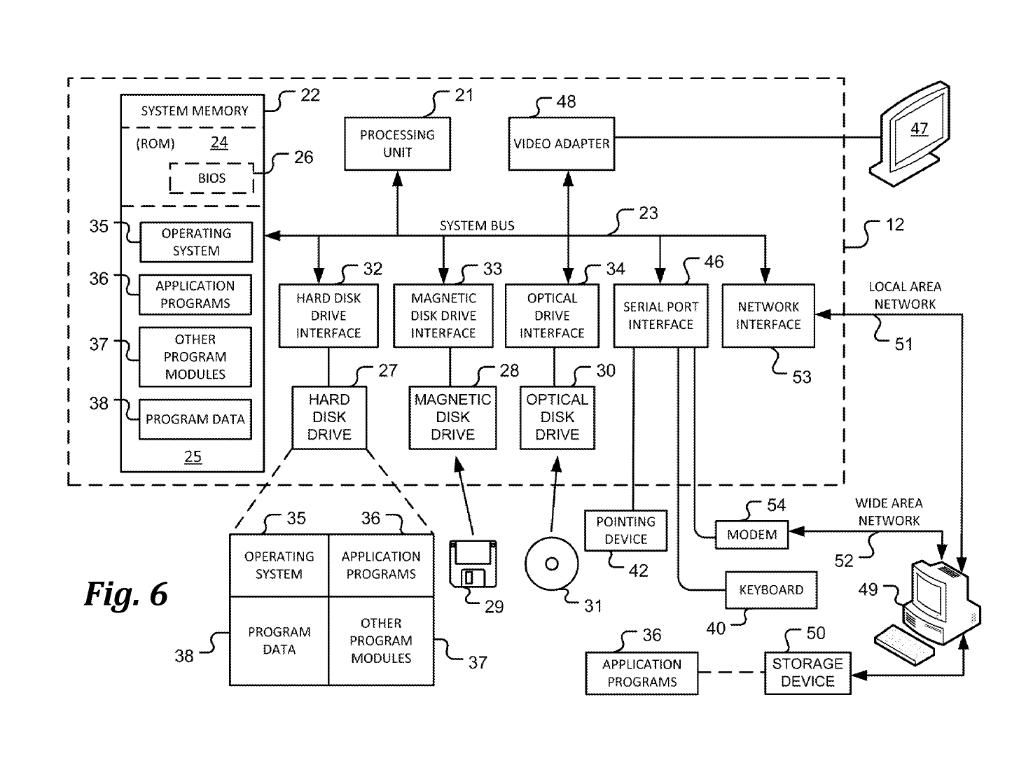

The management interface engine 123 may include or communicate with web server components (not shown) configured to present conventional webpages displayable by conventional Internet browser applications executing on computing devices, such as a computing device 12 illustrated in FIG. 6 and described below. The management interface presented by the management interface engine 123 may include one or more web pages that may be transmitted by the web server components (not shown) to other computing devices in the system 100 (see FIG. 1). Such web pages may be displayed by conventional Internet browser applications executing on the recipient computing devices.

As illustrated, the end user computing device 162A includes an executing application 214 and a heartbeat data store 210. The executing application 214 is the application for which user engagement is being tracked by the tracking system 120, and includes a tracking Software Development Kit (SDK) 216. The tracking SDK 216 includes functions and/or procedures that execute when selected events occur on the computing device 162A on which the application 214 is installed. For example, the tracking SDK 216 may include computer-executable instructions that execute when the application 214 is installed and used for the first time.

By way of a non-limiting example, the tracking SDK 216 may be implemented as a library file that is included in an application project used to create the application 214. An application developer may specify which particular functions are called from the library to indicate to the tracking engine 124 when install events and/or other in-application (“in-app”) events have occurred. As another non-limiting example, in some embodiments the functionality described herein as being provided by the tracking SDK 216 is not included in a library file that is included in the application project used to create the application 214, but is instead accessed by virtue of the application 214 performing remote function calls to an application programming interface (API) provided by the tracking engine 124 or other element of the tracking system 120.

As illustrated, the tracking SDK 216 includes a tracking identifier 266, a session identifier 206, a session identifier generation engine 204, and a heartbeat engine 202. The tracking identifier 266 is provided by the tracking system 120 and is stored by the end user computing device 162A for identifying communications to the tracking system 120. The session identifier 206 is generated by the session identifier generation engine 204 upon the start of a new user session in the executing application 214. The timing of such generation may be determined by the developer of the application 214, and may typically be timed to coincide with each time the application 214 is launched or re-launched. The heartbeat engine 202 creates heartbeat messages to be transmitted to the tracking engine 124 or stored in the heartbeat data store 210, as discussed further below.

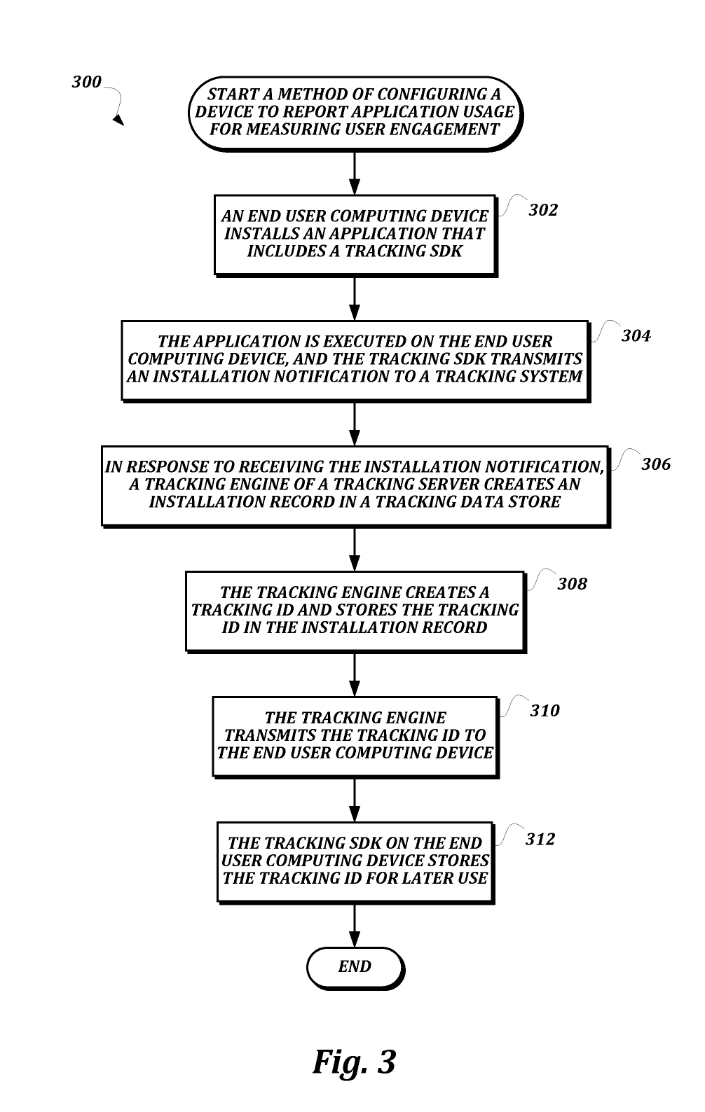

FIG. 3 is a flowchart that illustrates an exemplary embodiment of a method 300 of configuring a device to report application usage for measuring user engagement according to various aspects of the present disclosure. From a start block, the method 300 proceeds to block 302, where an end user computing device 162A installs an application 214 that includes a tracking SDK 216. As discussed above, in some embodiments, the tracking SDK 216 functionality may be incorporated into the application 214 by accessing an API provided by the tracking system 120, as opposed to being directly incorporated into the application 214, without departing from the scope of the present disclosure. A tracking SDK 216 incorporated directly into the application 214 is described for ease of discussion only, and one of ordinary skill in the art will understand that descriptions of an incorporated tracking SDK 216 also include embodiments wherein the described functionality is provided by a server-side API (unless otherwise stated).

From block 302, the method 300 proceeds to block 304, where the application 214 is executed on the end user computing device 162A, and the tracking SDK 216 transmits an installation notification to a tracking system 120. At block 306, in response to receiving the installation notification, a tracking engine 124 of a tracking server 122A creates an installation record 268 in a tracking data store 125. Next, at block 308, the tracking engine 124 creates a tracking identifier 266 and stores the tracking identifier 266 in the installation record 268.

At block 310, the tracking engine 124 transmits the tracking identifier 266 to the end user computing device 162A. Then, at block 312, the tracking SDK 216 on the end user computing device 162A stores the tracking identifier 266 for later use. In embodiments wherein the tracking SDK 216 functionality is provided by an API, the tracking identifier 266 may be stored on the end user computing device 162A by another component of the executing application 214. The method 300 then proceeds to an end block and terminates.

### Methods for Measuring Engagement

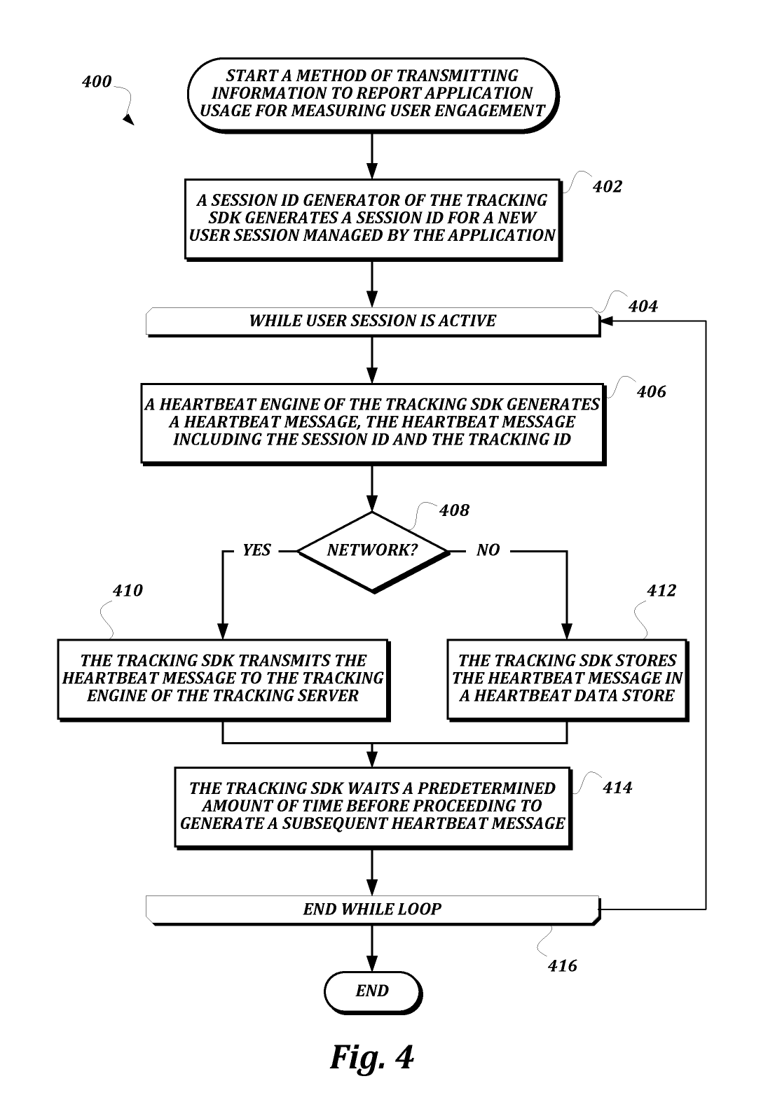

FIG. 4 is a flowchart that illustrates an exemplary embodiment of a method 400 of transmitting information to report application usage for measuring user engagement according to various aspects of the present disclosure. From a start block, the method 400 proceeds to block 402, where a session ID generator 204 of the tracking SDK 216 generates a session identifier 206 for a new user session managed by the application 214. In some embodiments, the session identifier is a universally unique identifier (UUID) as is known to one of ordinary skill in the art, though in other embodiments, any suitable technique may be used to generate the session identifier that is likely to generate a unique identifier for each session. For example, in some embodiments, the session identifier may be a combination of a count value and the tracking identifier 266, wherein the count value is incremented for each new user session.

The session itself is defined by the application provider 170 when developing the application. A typical user session may begin upon a launch of the application 214, and may end when the application 214 is closed. Another typical user session may begin upon a login, a start of application 214 functionality (such as the start of a game play session), or other action within the application 214 that indicates the user has begun interacting with the application 214, and may end upon logout or an end of a game play session even if the application 214 is still executing.

The method 400 then proceeds to a while loop defined between a while loop start block 404 and a while loop end block 416. Within the while loop 404-416, the method 400 includes actions that take place while a user session is active within the executing application 214.

From the while loop start block 404, the method 400 proceeds to block 406, where a heartbeat engine 202 of the tracking SDK 216 generates a heartbeat message, the heartbeat message including the session identifier 206 and the tracking identifier 266. The method 400 then proceeds to a decision block 408, where a determination is made regarding whether the end user computing device 162A has access to a network by which it can communicate with the tracking system 120. In response to determining that the result of the determination is YES, the method 400 proceeds to block 410, where the tracking SDK 216 transmits the heartbeat message to the tracking engine 124 of the tracking server 122A. Otherwise, in response to determining that the result of the determination is NO, the method 400 proceeds to block 412, where the tracking SDK 216 stores the heartbeat message in a heartbeat data store 210. Once in the heartbeat data store 210, the heartbeat message is stored until an opportunity arises to transmit the heartbeat message to the tracking engine 124. In some embodiments, the method 400 may check, at block 410, whether any stored heartbeat messages are present in the heartbeat data store 210, and may transmit the stored messages to the tracking engine 124 along with a new heartbeat message. In some embodiments, the tracking SDK 216 may detect when network connectivity is restored, and may transmit heartbeat messages stored in the heartbeat data store 210 at that time.

From either block 410 or block 412, the method 400 proceeds to block 414, where the tracking SDK 216 waits a predetermined amount of time before proceeding to generate a subsequent heartbeat message. In some embodiments, the predetermined amount of time is configured by the tracking system 120 or the application provider 170 to be a fixed amount of time, such as ten seconds. In some embodiments, the predetermined amount of time may change as time passes. For example, each time through the while loop 404-416, the predetermined amount of time may increase. The increasing wait times may be used to reduce overall bandwidth use and processing time as the length of the user session increases. Slight inaccuracies introduced by increasing the wait times (that is, a user session that is ended during a longer wait time between heartbeat messages would seem longer or shorter than if a fixed wait time was used) become less significant as the overall length of the user session increases.

The method 400 then proceeds to the while loop end block 416 where, if the user session is still active, the method 400 returns to the while loop start block 404. If the user session is no longer active, then the method 400 proceeds from the while loop end block 416 to an end block and terminates.

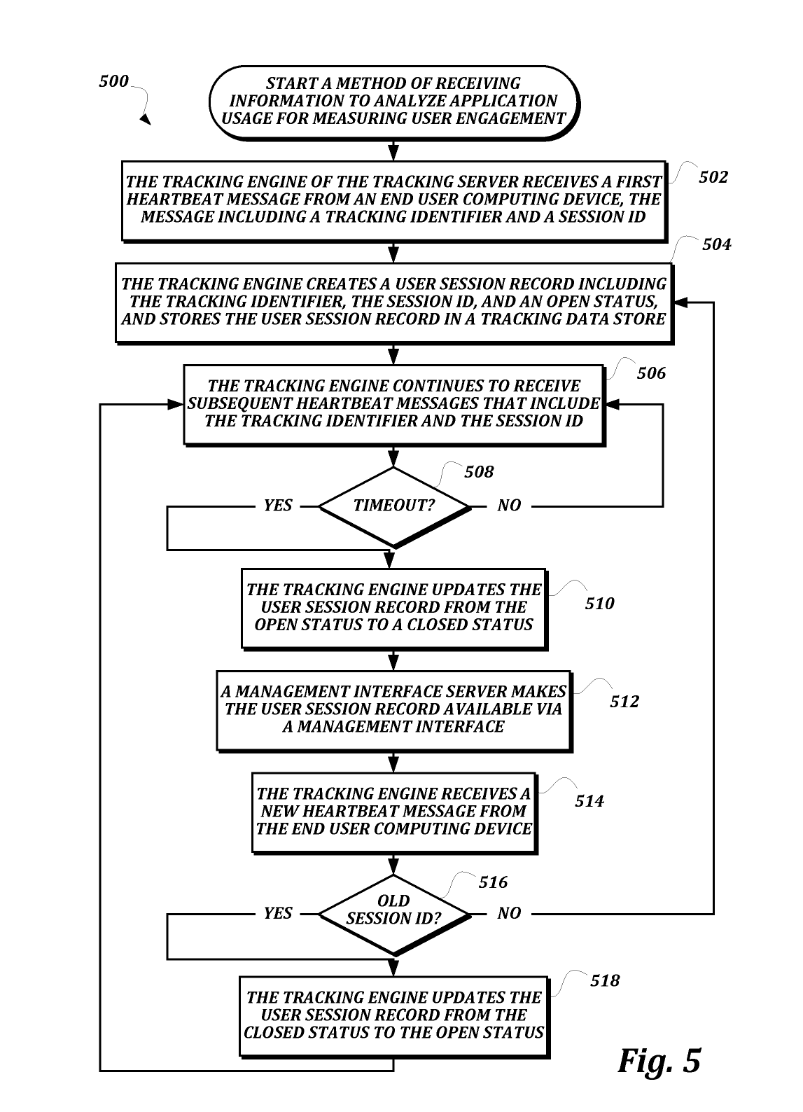

FIG. 5 is a flowchart that illustrates a method 500 of receiving information to analyze application usage for measuring user engagement according to various aspects of the present disclosure. From a start block, the method 500 proceeds to block 502, where the tracking engine 124 of the tracking server 122A receives a first heartbeat message from an end user computing device 162A, the heartbeat message including a tracking identifier 266 and a session identifier 206. One of ordinary skill in the art will recognize that the heartbeat message may be sent by the end user computing device 162A using the method 400 discussed above. At block 504, the tracking engine 124 creates a user session record 270 including the tracking identifier 266, the session identifier 206, and an open status, and stores the user session record 270 in the tracking data store 125.

Next, at block 506, the tracking engine 124 continues to receive subsequent heartbeat messages that include the tracking identifier 266 and the session identifier 206. In some embodiments, the method 506 may pause or otherwise wait in block 506 for the subsequent heartbeat message for a predetermined amount of time. The method 500 then proceeds to a decision block 508, where a determination is made as to whether the amount of time for which the tracking engine 124 waited in block 506 exceeded a timeout value. In some embodiments, the timeout value may be a fixed value, while in some embodiments, the timeout value may increase over time, similar to the discussion above with regard to the generation of heartbeat messages. In some embodiments, the timeout value may be set based on the expected predetermined amount of time between heartbeat messages generated by the tracking SDK 216.

If the determination at decision block 508 is that the timeout value was not exceeded (in other words, the subsequent heartbeat message was received before the predetermined amount of time had elapsed), then the result of the decision is NO, and the method 500 returns to block 506 to wait for a subsequent heartbeat message. Otherwise, if the determination at decision block 508 is that the timeout value was exceeded, the result of the decision is YES, and the method 500 proceeds to block 510.

At block 510, the tracking engine 124 updates the user session record from the open status to a closed status, and at block 512, a management interface server 122C makes the user session record available via a management interface 123. The management interface 123 may provide many types of analysis of user session information. For example, an application provider 170 may be able to submit a query via the management interface 123 for a given application 214 to view statistics for user engagement across all users of the application 214. These statistics may help the application provider 170 determine how much time users are spending engaged with their application overall. Even more powerful tools may be provided for analysis. For example, the tracking system 120 may associate user session records 270 with user click records 272 based on the tracking identifier 266. Accordingly, attribution for the user session records 270 may be provided to a mobile advertising publisher 150. In this way, an application provider 170 may be able to determine which mobile advertising publishers 150 are generating clicks and installs for high-value users (that is, users who spend more time engaging with the application 214) versus mobile advertising publishers 150 that are generating clicks and installs for low-value users (that is, users who install the application but do not engage much). In some embodiments, statistics may be provided by the management interface 123 for open user session records 270 as well, though because those sessions are not yet closed, the management interface 123 may have to make assumptions regarding the determined value of the users. In some embodiments, attribution of user session records 270 to mobile advertising publishers 150 may also be used to provide credit to the mobile advertising publishers 150.

At block 514, the tracking engine 124 receives a new heartbeat message from the end user computing device 162A. At decision block 516, a determination is made by the tracking engine 124 regarding whether the newly received heartbeat message matches a previously recorded user session record, or instead indicates a new user session. To do so, the tracking engine 124 may query the tracking data store 125 for a user session record 270 having the same tracking identifier 266 and session identifier 206. If a matching user session record is found, then the result of the determination at decision block 516 is YES, and the method 500 proceeds to block 518, where the tracking engine 124 updates the user session record from the closed status to the open status, and the method 500 returns to block 506 to await subsequent heartbeat messages. Otherwise, if no matching user session record is found, then the result of the determination at decision block 516 is NO, and the method 500 returns to block 504 to begin tracking the new user session.

Though the loop from block 502 to 518 is not illustrated as having an exit (as the method 500 represents a process that is executed for an undetermined amount of time by a tracking system 120), one of ordinary skill in the art will recognize that, when instructed by an administrator or when otherwise no longer needed, the method 500 terminates.

### Computing Device

FIG. 6 is a diagram of hardware and an operating environment in conjunction with which implementations of the one or more computing devices of the system 100 may be practiced. The description of FIG. 6 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, smartphones, network-connected tablet computers, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 6 includes a general-purpose computing device in the form of the computing device 12. Each of the computing devices of FIG. 1 (including the computing devices 122, 132, 142, 152, 162, and 172) may be substantially similar or identical to the computing device 12. By way of non-limiting examples, the computing device 12 may be implemented as a laptop computer, a tablet computer, a web enabled television, a personal digital assistant, a game console, a smartphone, a mobile computing device, a cellular telephone, a desktop personal computer, and the like.

The computing device 12 includes a system memory 22, the processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those skilled in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including the operating system 35, one or more application programs 36, other program modules 37, and program data 38. A user may enter commands and information into the computing device 12 through input devices such as a keyboard 40 and pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types of physical feedback (e.g., a force feed back game controller).

The input devices described above are operable to receive user input and selections. Together the input and display devices may be described as providing a user interface. The user interface is configured to display portions of the management interface 123 to appropriate users.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 6 include a local-area network (LAN) 51 and a wide-area network (WAN) 52. Such networking environments are commonplace in offices, enterprise-wide computer networks, intranets and the Internet. The network 180 (see FIG. 1) may be implemented using one or more of the LAN 51 or the WAN 52 (e.g., the Internet).

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port). Further, many laptop computers may connect to a network via a cellular data modem.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

In some embodiments, the system memory 22 stores computer executable instructions that when executed by one or more processors cause the one or more processors to perform all or portions of one or more of the methods (including the methods 300, 400, 500 illustrated in FIGS. 3, 4, and 5, respectively) described above. Such instructions may be stored on one or more non-transitory computer-readable media.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Accordingly, the invention is not limited except as by the appended claims.

The embodiments of the invention in which an exclusive property or privilege is claimed are defined as follows:

1. A computer-implemented method of determining end user engagement with an application installed on an end user computing device, the method comprising:
receiving, by a tracking server, a first heartbeat message from the end user computing device, wherein the heartbeat message includes a tracking identifier and a session identifier;
creating, by the tracking server, a user session record including the tracking identifier, the session identifier, and an open status;
detecting, by the tracking server, that a timeout period has elapsed without receiving a subsequent heartbeat message that includes the tracking identifier and the session identifier; and
updating, by the tracking server, the user session record from the open status to a closed status.

2. The method as recited in claim 1, further comprising:
receiving, by the tracking server, a new heartbeat message that includes the tracking identifier and the session identifier; and
updating, by the tracking server, the user session record from the closed status to the open status.

3. The method as recited in claim 1, wherein the timeout period is of a fixed duration.

4. The method as recited in claim 1, wherein the timeout period is of a duration that increases upon receiving subsequent heartbeat messages that include the tracking identifier and the session identifier.

5. The method as recited in claim 1, wherein updating the user session record from the open status to the closed status includes making the user session record available in a management interface.

6. The method as recited in claim 1, further comprising:
receiving, by the tracking server, an installation notification for the application from the end user computing device; and
sending, by the tracking server, the tracking identifier to the end user computing device.

7. The computer-implemented method as recited in claim 1, further comprising storing the user session record in a tracking data store.

8. The computer-implemented method as recited in claim 1, wherein the session identifier is a universally unique identifier (UUID).

9. The computer-implemented method as recited in claim 1, wherein the end user computing device is a mobile computing device.

10. A nontransitory computer-readable medium having computer-executable instructions stored thereon that, in response to execution by one or more processors of an end user computing device, cause the end user computing device to perform actions for measuring user engagement with an application installed on the end user computing device, the actions comprising:
generating, by the end user computing device, a session identifier in response to detecting a launch of the application;
creating, by the end user computing device, a heartbeat message that includes the session identifier and a tracking identifier associated with the end user computing device; and
creating, by the end user computing device, a subsequent heartbeat message that includes the session identifier and the tracking identifier after waiting a predetermined amount of time.

11. The computer-readable medium as recited in claim 10, wherein the predetermined amount of time increases for each subsequent heartbeat message.

12. The computer-readable medium as recited in claim 10, wherein the actions further comprise:
determining whether a tracking server is accessible via a network;
in response to determining that the tracking server is not accessible, storing the heartbeat message in a heartbeat data store on the end user computing device; and
in response to determining that the tracking server is accessible, transmitting the heartbeat message to the tracking server.

13. The computer-readable medium as recited in claim 12, wherein transmitting the heartbeat message to the tracking server includes transmitting one or more heartbeat messages stored in the heartbeat data store to the tracking server.

14. The computer-readable medium as recited in claim 10, wherein the actions further comprise:
transmitting, by the end user computing device, an installation notification to the tracking server; and
receiving, by the end user computing device, the tracking identifier from the tracking server.

15. The computer-readable medium as recited in claim 10, wherein the session identifier is a universally unique identifier (UUID).

16. A tracking system, comprising:
a storage service server configured to provide a tracking data store; and
a tracking server configured to provide a tracking engine configured to:
receive a first heartbeat message from an end user computing device, wherein the heartbeat message includes a tracking identifier and a session identifier;
store a user session record in the tracking data store, the user session record including the tracking identifier, the session identifier, and an open status;
detect that a timeout period has elapsed without receiving a subsequent heartbeat message that includes the tracking identifier and the session identifier; and
update the user session record from the open status to a closed status.

17. The tracking system as recited in claim 16, further comprising a management interface server configured to provide a management interface that provides information relating to user session records having the closed status.

18. The tracking system as recited in claim 16, wherein the tracking engine is further configured to:
receive a new heartbeat message that includes the tracking identifier and the session identifier; and
update the user session record from the closed status to the open status.

19. The tracking system as recited in claim 16 wherein the timeout period is of a fixed duration.

20. The tracking system as recited in claim 16, wherein the timeout period is of a duration that increases upon receiving subsequent heartbeat messages that include the tracking identifier and the session identifier.

21. The tracking system as recited in claim 16, wherein the tracking engine is further configured to:
receive an installation notification for the application from the end user computing device; and
send the tracking identifier to the end user computing device.

22. The tracking system as recited in claim 16, wherein the session identifier is a universally unique identifier (UUID).

23. The tracking system as recited in claim 16, wherein the end user computing device is a mobile computing device.
